(19) United States
(12) Patent Application Publication
(10) Pub. No.: US 2007/0000514 A1
(43) Pub. Date: Jan. 4, 2007

(54) Device for delivering substances to a selected environment such as the human mouth and method for making the same

(76) Inventors: Tracy O'Shaughnessey, Highlands Ranch, CO (US); Carol L. Wilke, Highlands Ranch, CO (US)

Correspondence Address: MARTIN & HENSON, P.C., 9250 W 5TH AVENUE, SUITE 200, LAKEWOOD, CO, 80226, US

(21) Appl. No.: 11/450,955

(22) Filed: Jun. 9, 2006

Related U.S. Application Data
(60) Provisional application No. 60/689,322, filed on Jun. 9, 2005.

(51) Int. Cl. A61C 15/00

(52) U.S. Cl. 132/321

(57) ABSTRACT

An article of manufacture delivers a substance to a selected environment. In an embodiment, the article includes a substrate with at least a portion formed of a porous first material into which an active ingredient is impregnated, and a protective layer of a second material extends over a surface area of said portion to reduce degradation of the active agent. The article may be an oral device, such as a toothpick or chewing stick. The porous first material may be bamboo, and the protective layer is optional. An optional anti-stick layer covering a portion of the protective layer is also disclosed. A method for producing the oral device is also disclosed.

### TECHNOLOGICAL FIELD

The present invention broadly relates to devices that can be used to deliver a selected compound or composition to an environment. The exemplary embodiments disclosed herein are particularly useful as oral devices, such as toothpicks or chew sticks, to deliver flavors, anti-craving compounds, medicaments, herbal extracts, analgesics, etc., that provide these compounds for human intake or pleasure. The invention also relates to a method for making such devices.

### BACKGROUND OF THE DISCLOSURE

Several flavored oral devices are available on the market. Such devices may be useful for a variety of purposes, such as satisfaction of the user, removal or covering of oral odor, satisfaction of a perceived or real need for a certain flavor or oral sensation, removal of plaque or other substance in the mouth or teeth, and so forth. These oral devices, for example, can be in the form of toothpicks or chew sticks.

Toothpicks are generally configured as elongated slivers of a material, such as birch wood, bamboo or plastic, having at least one sharp end for probing between a person's teeth to remove unwanted food particles. It has been known to impart a flavor to birch wood toothpicks by dusting them with a spice, such as cinnamon. It has also been known to infuse birch wood toothpicks with a beneficial oil, such as the oil of the tea tree. However, these toothpicks rapidly lose their flavor due to escape of volatile components, especially from evaporation. This means that the products have a diminished shelf life. In addition, users of such products often complain that the flavor is not long lasting.

Chew sticks, on the other hand, are generally elongated, but have a greater thickness than toothpicks. Thus, chew sticks have a smaller ratio of length to diameter than toothpicks. The user primarily chews on the chew stick with the teeth to release flavor or a naturally present beneficial compound. An example is a twig or root from the licorice bush which is believed to contain natural antibiotics. Homeopathic use of licorice for gastric irritation also dates back to the first century.

Further, it has been suggested that an oral device, whether a chew stick or a toothpick, may by helpful in the overcoming of habits such as smoking. However, the available oral devices either do not last long enough to assist the person in overcoming the initial urge, or do not fulfill all of the chemical and tactical cravings during use, or have deleterious side effects.

Accordingly, there exists a need for a devices that can deliver selected substances to a selected environment, such as the human mouth. There is a need for such products to have increased shelf life. There is a further need for such products to provide extended release of the select substances so as to increase satisfaction to the user and/or increase the beneficial effects of the substances for the user.

### SUMMARY OF THE DISCLOSURE

It is an object of the present invention to provide a new and useful article of manufacture that is adapted to deliver a desired substance to a selected environment.

According to one aspect of the exemplary embodiments, an article of manufacture is constructed so as to provide a longer shelf life for the substance to be delivered.

According to another aspect of some of the exemplary embodiments of the present invention, an article of manufacture using bamboo as a substrate is contemplated.

A still further aspect of some of the exemplary embodiments of the present invention is to provide an oral device that is adapted to be received in a person's mouth for delivering a selected substance to the person in the form of flavorings, medicaments, analgesics, herbal extracts, vitamins, minerals, etc.

It is also an object of the present invention to provide a method of manufacturing articles of manufacture according to the exemplary embodiments.

According to the exemplary embodiments of the present invention, then, an article of manufacture, which may optionally be an oral device, is adapted to deliver a desired substance to a selected environment. Broadly, this article of manufacture may include a substrate having at least a portion thereof that is formed of a selected porous first material. An active ingredient is then impregnated into this portion of porous material, and a protective layer may be formed of a second material that extends over a surface area of the portion with this layer being operative to reduce degradation of the active agent.

The selected porous material for the substrate may be wood, bamboo or engineered materials. According to one exemplary embodiment, such material is selected to be wood and the protective layer is omitted. The substrate may be configured in any desired manner, such as the toothpick or other elongated rod, for example, a chewing stick, or as a lozenge, disk, spoon or otherwise. Indeed, the entire substrate may be formed of the porous first material or may be a piece of porous first material that is supported by a nonporous material, such as a plastic handle.

The active agent may likewise be selected from a variety of compounds. For example, the active agent may be selected from a group consisting of anti-craving compounds, medicaments, herbal extracts, analgesics, vitamins, minerals, and the like. The active agent may be in the form of a volatile oil that is infused into the porous first material.

The protective layer may likewise be formed of a material that is selected to breakdown in the selected environment. For example, where the environment is intended to be the human mouth, the protective layer may be selected so as to breakdown in the human mouth due to the action of moisture, saliva components, chewing or the like. Here, for example, the protective layer may be formed of gum arabic and inulin. If desired, a thin layer or dusting of an anti-stick compound, such as xylitol, may be provided over the protective layer to reduce adhesion of multiple devices, such as toothpicks, to one anther.

According to the exemplary embodiment of the method, a process of producing a device that is adapted to be received in a selected environment comprises a first step of providing a substrate that has at least an insert portion thereof that is formed of the selected porous material and that is sized and adapted for being placed in the selected environment. The method then includes the step of impregnating the insert portion with an active agent and afterwards forming a protective layer of a second material over a surface area of the insert portion whereby the protective layer is operative to reduce degradation of the active agent.

### BRIEF DESCRIPTION OF THE DRAWINGS

FIG. 1 is a perspective view of an article of manufacture according to a first exemplary embodiment of the present invention, here in the form of a toothpick;

FIG. 2 is a side view in elevation of a chewing stick according to a second exemplary embodiment of the present invention;

FIG. 3 is a third configuration, here in the form of a spoon, of a third exemplary embodiment of the present invention;

FIG. 4 is a top plan view of a fourth exemplary embodiment of the present invention;

FIG. 5 is a perspective view of a fifth exemplary embodiment of the present invention;

FIG. 6 is a cross-sectional view taken about lines 6-6 of FIG. 2; and

FIG. 7 is a diagrammatic view representatively showing production equipment that is used to practice the method of manufacture of the devices according to the exemplary embodiments of the present invention.

### DETAILED DESCRIPTION OF THE EXEMPLARY EMBODIMENTS

The present invention broadly relates to devices that can be used to deliver a selected compound or composition to a selected environment. According to the exemplary embodiments described herein, such articles of manufacture are illustrated to be those that can deliver a selected active agent to an environment, such as the human mouth, a beverage, etc. Examples of such active agents can be virtually any desired composition that can be impregnated into a porous substrate, with such active agents being flavorings, anti-craving compounds, medicaments, herbal extracts, analgesics, vitamins, minerals, and the like. Accordingly, when used herein and in the appended claims, the term “active agent” is to be read expansively and as broadly encompassing any such materials that may be ingested for pleasure, health, and general well-being, including without limitation, flavors, anti-craving compounds, medicaments, herbal extracts, analgesics, vitamins, minerals, enzymes, antioxidants, fatty acids and the like.

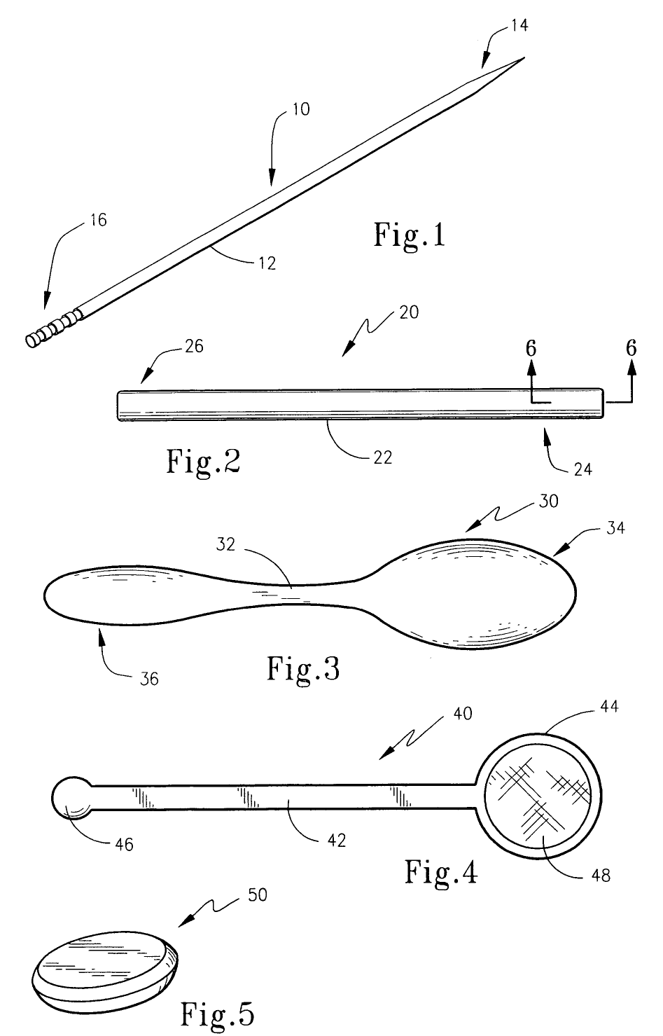

A first exemplary embodiment according to the present invention, then, is illustrated in FIG. 1 wherein an article of manufacture in the form of an oral device comprising toothpick 10 is illustrated. Toothpick 10 is in the form of a substantially elongated shaft 12 that is generally circular in cross-section, although other cross-sectional shapes are certainly within the scope of this invention. For example, shaft 12 could be oval or polygonal (triangular, etc.) in cross-section. In any event, a first end 14 of shaft 12 terminates in a point that may be used to dislodge plaque or other substances from the mouth, for example, as between the teeth. A second end 16 of shaft 12 may be tooled to provide a gripping portion for a person's fingers where otherwise shaped so as to provide a dental hygienic device or other structure.

FIG. 2 depicts a second exemplary embodiment of the present invention wherein the article of manufacture is again in the form of an oral device in the form of a chewing stick 20. Here again, stick 20 is formed by an elongated shaft 22 that terminates in blunted first and second ends 24 and 26. Shaft 22 may again have a circular cross-section, but here the diameter of shaft 22 is thicker so that the ratio of the length of shaft 22 to its diameter is less than the ratio of the length of shaft 12 to its respective diameter.

FIGS. 3, 4 and 5 disclose additional possible configurations of the article of manufacture according to the present invention which would be deemed as non-limiting illustrations of some of the possible shapes for which this article of manufacture may take. Thus, in FIG. 3, the article of manufacture is in the form of a stirring spoon 30 that has a shaft 32 that is rather flattened in shape and supports, at one end thereof, an insert portion in the form of a spoon head 34 and a handle portion 36 opposite spoon head 34. Spoon 30 could also be a somewhat of a lollipop for insertion into a person's mouth. In FIG. 4, the article of manufacture is in the form of a lollipop-like stirring stick or chew stick 40 having a plastic shaft 42 that includes a plastic support ring 44 at one end thereof and a plastic knob 46 at an opposite end thereof. Here, support ring 44 defines a support for a piece 48 of porous material, as described below. Finally, FIG. 5 illustrates yet another exemplary embodiment of an article of manufacture according to the present invention, here in the form of a lozenge 50 formed of porous material, again as described below.

In FIG. 1, toothpick 10 is formed entirely out of a selected porous first material, such as wood, bamboo, engineered materials (such as plastics), and the like. Likewise, chewing stick 20 of FIG. 2 and spoon 30 of FIG. 3 are formed out of this porous first material. In FIG. 4, stirring stick or lollipop 40 may be formed of a non-porous plastic material that supports a piece 48 of porous material. Here, shaft 42, support ring 44 and knob 46 may be integrally molded of the plastic material with piece 48 of porous material being adhered, mechanically supported or otherwise retained by support ring 44.

From the foregoing, it should be understood that the article of manufacture according to the present invention thus includes a substrate that supports a portion thereof that is formed of a selected porous first material, such as wood, bamboo, engineered material and the like. It is desirable that this portion of porous material be used to deliver a desired substance to the selected environment. Accordingly, the entire substrate may be formed of a selected porous material (such as toothpick 10, chewing stick 20, spoon 30 and lozenge 40) or may only have a portion thereof that is formed of the porous material (such as stirrer/lollipop 40).

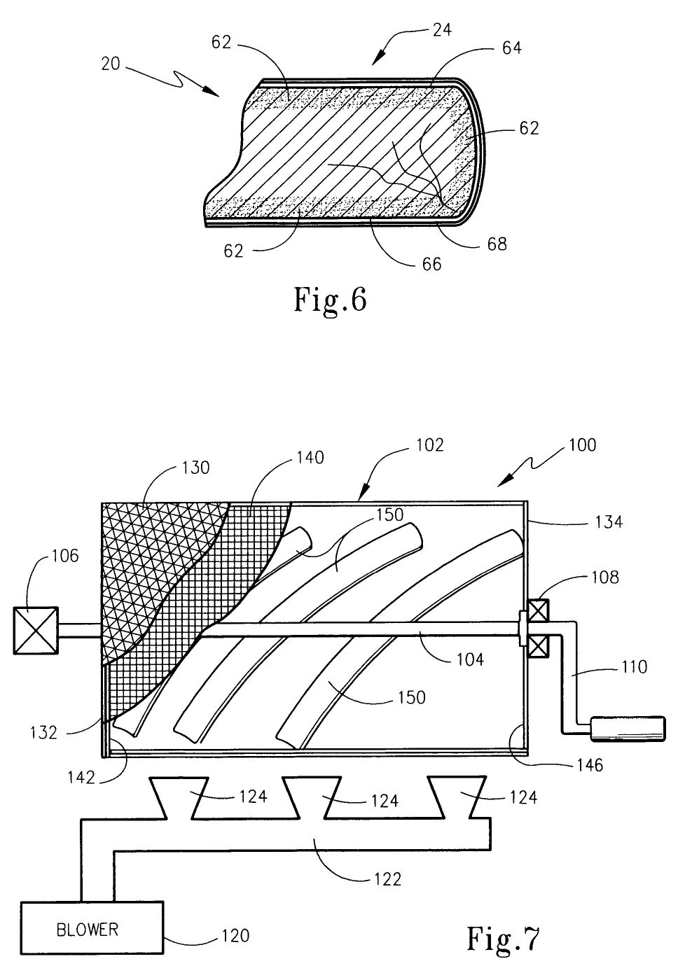

In any event, a portion of the article defines an insert portion that may be introduced into the selected environment. For purposes of explanation, reference in this regard is made to chewing stick 20 of FIG. 2, but it should be understood that the principles apply to any of the embodiments or other structures that would be apparent to the artisan having read this description. Therefore, with reference to FIG. 6, an end portion 24 of chewing stick 20 may form the insert portion and includes an active agent 62 that is impregnated therein. The terms “impregnated” or “impregnating” are intended to have expansive definitions that may include infusions, diffusions, the embedding or otherwise infiltrating or placement in any manner of the active agent into a marginal layer adjacent the surface 64 of substrate.

As part of the active agent, a sweetener may be added. Any sweetener known in the art may be used. Non-limiting examples of sweeteners known in the art include sugar sweeteners such as monosaccharides, disaccharides and polysaccharides. Examples of suitable sugar sweeteners include but are not limited to xylose, ribose, glucose, mannose, galactose, fructose, dextrose, sucrose, maltose, partially hydrolyzed starch (such as maltitol syrup) or corn syrup solids and sugar alcohols such as sorbitol, xylitol, mannitol, glycerin and combinations thereof.

Moreover, to increase the shelf life of the active agent, a protective layer, such as layer 66 may be placed on the impregnated substrate so as to extend over a surface area of the porous portion. This layer is selected to reduce degradation of the active agent. The term “degradation” is used to include chemical breakdown, evaporation or other volatilization of desired components, breakdown due to sunlight, oxidation and the like, or any other physical or chemical process that reduces the desired potency and/or effect (such as flavor) of the active agent. In addition, since it is intended that the portion of the substrate containing the active agent is to be placed in a selected environment, such as the human mouth, it is further desirable that the protective layer 66 be formed of a material that will break down in the selected environment so as to help release the active agent. For example, breakdown could occur due to the presence of moisture, other components of human saliva, mechanical action of the teeth, and the like.

For example, where the article of manufacture is intended to be an oral device, a suitable protective layer may be formed out of a coating of gum arabic and inulin and that may include any residual water. Further, since multiple units of the toothpicks or other oral devices may be packaged in a group, it is desirable to reduce adherence of adjacent ones of such articles. Accordingly, a second layer 68 of an anti-stick compound may be applied over the protective coating.

With reference now to FIG. 7 and to the following description, it should be understood that the present invention contemplates a method of producing articles of manufacture, including oral devices, as described herein. For sake of illustration, the manufacturing process will be described with respect to a toothpick, such as toothpick 10 of FIG. 1, to be impregnated wilth, for example, a volatile oil. According to the method, it is first necessary to provide a substrate out of a selected porous material. Toothpick substrates made from wood (such as birch), bamboo, and other materials are readily available from a variety of vendors. According to the present invention, bamboo is a particularly suitable substrate since it has high fiber strength, absorption characteristics (due to its porousity) and durability against mechanical breakdown. Accordingly, an ensemble of such bamboo toothpick substrates are first provided for impregnation with the active ingredient.

In the impregnation step, an ensemble of such substrates are placed in a steam jacketed kettle and the volatile oil is added so that the surface of the oil is above the surface level of the substrates. The steam jacket kettle is then covered by a lid and heated to approximately 195 degrees Fahrenheit for one hour causing pressure to help infuse the volatile oil deep into the substrate. After this process, excess oil is removed from the substrates which leaves an ensemble of the substrates that are impregnated with the volatile oil yet are still wet and oily on the surface.

Therefore, it is necessary to remove this surface oil, and this is accomplished by blow-drying the impregnated substrates with cool, dry, filtered air. To this end, and with reference to FIG. 7, the ensemble of oily substrates may be placed in a drum roller 100 diagrammatically illustrated in FIG. 7. Here, drum apparatus 100 includes a cylindrical duck drum 102 that is affixed to axle 104 that is rotatably journaled on bearings 106 and 108 so that it may be turned by handle 110 or, more preferably, a motorized drive.

In any event, a blower 20 is provided which may selectively blow air, at ambient temperature, to a manifold 122 and blower outlets 124 that are positioned proximately to cylinder 102. Cylinder 102, in turn, is formed by a hollow cylindrical shell 130 formed of an expanded metal having expanded metal end 132 and 134. Sleeve 130 and ends 132 and 134 are lined by a sleeve of stainless steel mesh 140, 142 and 146 with this being selected be a stainless steel food grade mesh. Optional baffles 150 may be provided to help stir substrates placed therein during a mechanically tumbling operation, as is well known in the art.

In any event, the wet, oily substrates are removed from the steam jacketed kettle and placed in drum apparatus 100, and the substrates are tumbled dry until sufficient oil is removed that the substrates become dry enough to apply the protective layer. The substrates are then ready for an encapsulation step wherein the protective layer is formed over the surface of the porous substrate containing volatile oil.

Where the article of manufacture is intended to be an oral device, a suitable protective layer may be formed by a composition formulated of 16 oz. inulin, 7 oz. gum arabic and 1 quart of water. These ingredients are mixed in the described ratio and are blended, after which the blended mixture is allowed to sit for at least 5 minutes prior to use on the substrates. When ready, the substrates are sprayed with the protective layer mixture which spraying may be done in situ within the drum apparatus 100. After coating the substrates with the sprayed on protective layer, the substrates are again tumble dried under the filtered ambient air until they are dry.

Other possible protective layer forming compounds are contemplated by this invention, with those compounds being any currently known or hereinafter developed. Examples of some such compounds include: talha (another type of acacia), alginate, cellulosics, vegetable gums, and so forth. The protective layer may also include low molecular weight water-soluble molecules such as, for example, mono-, di- and oligo-saccharidcs, especially glucose, fructose, maltose, sucrose, lactose, maltodcxtrin and inulin or polyhydroxy compounds, especially xylitol, mannitol, sorbitol, lactitol, mallilol and isomalt.

The above-described process produces a very usable article; however, it has been observed that, where multiple units are packaged in a common package, there may be some tendency for the articles to stick together due to adhesion of the protective layer of one article to another. Accordingly, once dry, and prior to packaging, it has been found desirable to apply and anti-sticking layer to the articles in order to prevent such adhesion to one another. For example, an anti-sticking layer may be formed by dusting the impregnated, protected and dried substrates with a natural sugar, such as xylitol or the like.

As noted, the article described may be used as an adjunct in overcoming habits or addictions or help curb cravings such as smoking. Numerous natural ingredients and/or essential oils are believed to possess such properties. An oral device is useful because it is something that is instinctively placed in a user's mouth, similar to cigarettes for smokers. Additionally, it is a physical object that allows the user to concentrate on something besides his/her craving. Many people already have the habit of having a toothpick, cigarette, pencil, or coffee stir stick in their mouth, making the transition from smoking to using the flavored oral device very easy. Examples of such compounds include Caladium Seguinum, Plantago Major, Cinchona Officinalis, Lobelia Inflate, Nux Vomica, Staphysagria, Calcarea Phosphorica, and Ignatia Amara.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

I claim:

1. An article of manufacture adapted to deliver a desired substance to a selected environment, comprising:
(A) a substrate having at least a portion thereof that is formed of a selected porous first material;
(B) an active agent impregnated in said portion; and
(C) a protective layer formed of a second material extending over a surface area of said portion, said layer being operative to reduce degradation of said active agent.

2. An article of manufacture according to claim 1 wherein said protective layer of material is selected to break down in the selected environment.

3. An article of manufacture according to claim 1 wherein said substrate is entirely formed of said porous first material.

4. An article of manufacture according to claim 1 wherein said active agent is a volatile oil.

5. An article of manufacture according to claim 1 wherein said active agent is selected from a group consisting of: flavors, anti-craving compounds, medicaments, herbal extracts, analgesics, vitamins, minerals, enzymes, antioxidants, and fatty acids.

6. An article of manufacture according to claim 1 wherein said second material is selected from a group consisting of: gum arabic, inulin and mixtures thereof.

7. An article of manufacture according to claim 1 wherein the selected environment is a human mouth, said portion of said substrate being sized and adapted to be placed in the mouth of a person.

8. An article of manufacture according to claim 1 wherein said substrate is configured as an elongated rod.

9. An article of manufacture according to claim 8 wherein said elongated rod is configured as a toothpick.

10. An article of manufacture according to claim 1 including an anti-sticking compound applied to the protective layer.

11. An oral device adapted to be received in a person's mouth, comprising:
(A) a substrate having at least an insert portion thereof that is formed of bamboo and that is sized and adapted to be placed in the mouth of a person; and
(B) an active agent impregnated within said insert portion.

12. An oral device according to claim 11 including a protective layer formed of a second material extending over a surface area of said portion, said layer being operative to reduce degradation of said active agent.

13. An oral device according to claim 12 wherein said second material is selected such that said protective layer will break down in an oral environment.

14. An oral device according to claim 12 including an anti-sticking compound applied to the protective layer.

15. An article of manufacture according to claim 11 wherein said substrate is entirely formed of said porous first material.

16. An article of manufacture according to claim 11 wherein said active agent is a volatile oil.

17. An article of manufacture according to claim 11 wherein said active agent is selected from a group consisting of: flavors, anti-craving compounds, medicaments, herbal extracts, analgesics, vitamins, minerals, enzymes, antioxidants, and fatty acids.

18. An article of manufacture according to claim 11 wherein said substrate is configured as an elongated rod.

19. An article of manufacture according to claim 18 wherein said elongated rod is configured as a toothpick.

20. An oral device adapted to be received in a person's mouth, comprising:
(A) a substrate having at least an insert portion thereof that is formed of a selected porous material and that is sized and adapted to be placed in the mouth of a person;
(B) an active agent impregnated within said insert portion; and
(C) a protective layer of material extending over a surface area of said insert portion, said layer being operative to reduce degradation of said active agent; and
(D) an anti-stick layer formed over at least a portion of said protective layer.

21. A method of producing an oral device that adapted to be received in a person's mouth, comprising:
(A) providing a substrate having at least an insert portion thereof that is formed of a selected porous material and that is sized and adapted to be placed in the mouth of a person;
(B) impregnating said insert portion with an active agent; and
(C) forming a protective layer of second material over a surface area of said insert portion wherein said layer is operative to reduce degradation of said active agent.
